(19) United States
(12) Patent Application Publication
(10) Pub. No.: US 2022/0325854 A1
(43) Pub. Date: Oct. 13, 2022

(54) Vehicle Mounted Monitoring System for Removable Propane Tanks

(71) Applicant: Gary David Harris, Porterville, CA (US)

(72) Inventor: Gary David Harris, Porterville, CA (US)

(21) Appl. No.: 17/568,101

(22) Filed: Jan. 4, 2022

Related U.S. Application Data
(60) Provisional application No. 63/173,891, filed on Apr. 12, 2021.

(51) Int. Cl. F17C 13/08; F17C 13/02; G01F 22/00

(52) U.S. Cl. CPC F17C 13/083; F17C 13/02; G01F 22/00; F17C 2205/0103; F17C 2221/035; F17C 2270/0168; F17C 2205/013

(57) ABSTRACT

A vehicle mounted monitoring system for removable propane tanks includes a propane tank holding system, at least one tank measuring sensor, a hard-wired vehicular power connection, a main control module, and a vehicular display module. The propane tank holding system includes at least one resting bracket so that a propane tank can be placed and secured. The tank measuring sensor is operatively coupled to the resting bracket to measure the remaining amount of liquid in the propane tank. The hard-wired vehicular power connection is electrically connected to the tank measuring sensor for continuous operation. The tank measuring sensor is electronically connected to the vehicular display module through the main control module so that the user can be informed.

The current application claims a priority to the U.S. Provisional Patent application Ser. No. 63/173,891 filed on Apr. 12, 2021.

### FIELD OF THE INVENTION

The present invention relates generally to a system for measuring the amount of remaining liquid propane of propane tanks. More specifically, the present invention provides a reliable vehicle mountable monitoring system that utilizes a sensor to measure the remaining liquid propane of the propane tanks and displays the measurement for a user.

### BACKGROUND OF THE INVENTION

A recreational vehicle is a large motor vehicle that includes living quarters designed for accommodation. The recreational vehicle uses a propane system to provide heat and hot water, power for the stove and refrigerator, power small appliances, and power many other accessory units of the recreational vehicles. In the industry, there are many methods to measure the remaining amount of liquid in a propane tank such as correlating the temperature difference between the liquid propane and gas, directly measuring the pressure of the propane tank, or measuring the weight of the propane tank. However, these methods are generally inaccurate and have to be manually completed by the user. Aftermarket products that measures the remaining amount of liquid in a propane tank generally requires regular maintainers such as changing batteries. As a result, aforementioned methods are either inconvenient, inaccurate, or unreliable for users of the recreational vehicles.

An objective of the present invention is to provide a propane tank monitoring system that can be mounted on a standard propane tank rack of a recreational vehicle. The present invention measures the remaining amount of liquid in propane tanks and displays the measurements on a display device. Utilizing the present invention, a user can monitor the status of the propane tanks conveniently and accurately at any time. The present invention is hard wired into the vehicular power source (main battery) to ensure sufficient electrical power is continuously supplied. Additional features and benefits are further discussed in the sections below.

### BRIEF DESCRIPTION OF THE DRAWINGS

FIG. 1 is a perspective view of the propane tank holding system of the present invention, wherein two removable propane tanks are installed within.

FIG. 2 is a perspective view of the propane tank holding system of the present invention.

FIG. 3 is a side view of the propane tank holding system of the present invention, showing the plane upon which a cross sectional view is taken shown in FIG. 4.

FIG. 4 is a cross section view of the propane tank holding system of the present invention taken along line 4-4 in FIG. 3.

FIG. 5 is a detailed view for the resting bracket of the present invention taken about circle 5 in FIG. 4.

FIG. 6 is a schematic diagram showing the electrical connection between the hard-wired vehicular power connector and the at least one tank measuring sensor.

FIG. 7 is a schematic diagram showing the electronical connection between the at least one tank measuring sensor, the main control module, and the vehicular display module.

### DETAIL DESCRIPTIONS OF THE INVENTION

All illustrations of the drawings are for the purpose of describing selected versions of the present invention and are not intended to limit the scope of the present invention.

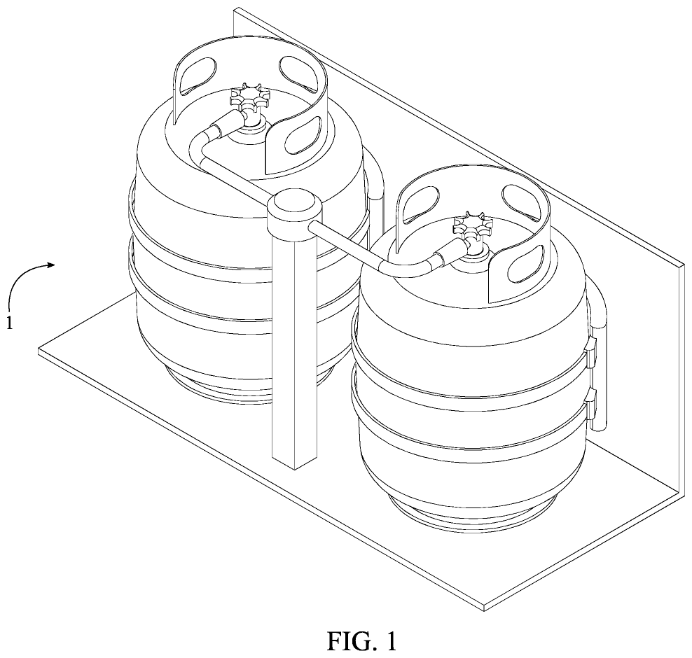

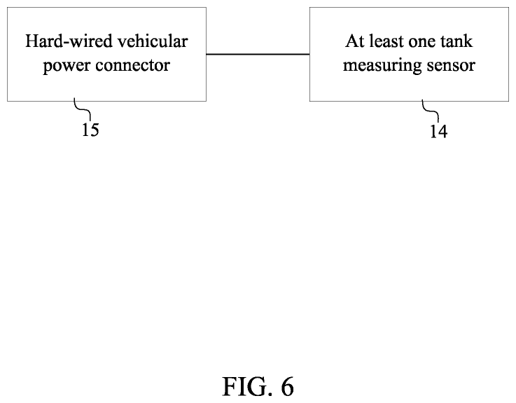

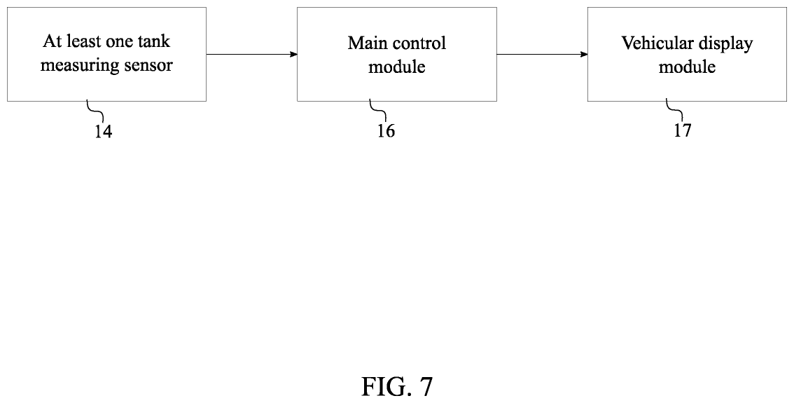

The present invention is a vehicle mounted monitoring system for removable propane tanks to measure the remaining amount of liquid inside of the removable propane tank conveniently. The present invention is also able to accurately and display the measurements for a user. The removable propane tanks are generally mounted within the recreational vehicle so that the recreational vehicle can be provided with a source of energy for heating water, powering appliances, and other recreational activities that requires an energy source. As can be seen in FIG. 1 and FIGS. 5-7, the present invention comprises a propane tank holding system 1, at least one tank measuring sensor 14, a hard-wired vehicular power connector 15, a main control module 16, and a vehicular display module 17.

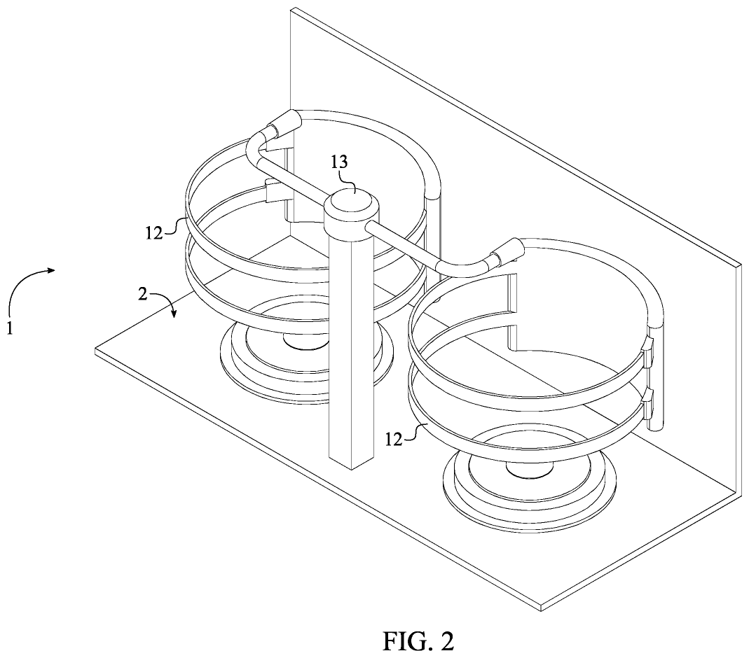

In reference to the general configuration of the present invention, as shown in FIG. 2 and FIGS. 5-7, the propane tank holding system 1 that secures the removable propane tanks comprises at least one resting bracket 2. The resting bracket 2 allows the proper placement of the removable propane tanks to prevent horizontal displacement. The tank measuring sensor 14 is operatively coupled to the resting bracket 2, wherein the tank measuring sensor 14 continuously measure the remaining amount of liquid in the removable propane tanks. The hard-wired vehicular power connector 15 that function as a direct power source from the vehicular battery is electrically connected to the tank measuring sensor 14. As a result, the tank measuring sensor 14 is directly powered within the present invention. The tank measuring sensor 14 is electronically connected to the vehicular display module 17 through the main control module 16 so that the user can be informed about the remaining amount of liquid in the removable propane tanks. Due to the hard-wired vehicular power connector 15, the user do not have to worry about the functionality and operation of the tank measuring sensor 14 in comparison to existing battery operated measuring sensors.

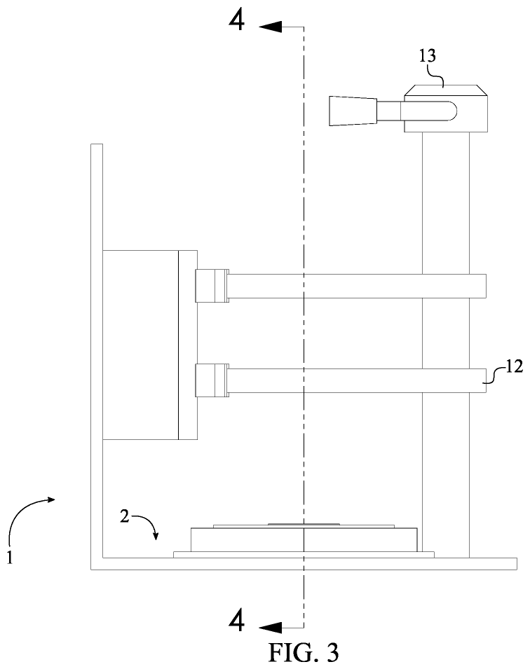

The propane tank holding system 1 is integrated or retrofitted into the recreational vehicle so that the removable propane tanks can be securely mounted to the recreational vehicle. Generally, the propane tank holding system 1 can be configured as a pull rack that can be enclosed within a vehicular compartment, opened rack that can be easily accessible, a hidden compartment, or any other types of functional configurations. As shown in in FIG. 3, the propane tank holding system 1 further comprises at least one mounting mechanism 12 and a vehicular propane inlet regulator 13 in addition to the resting bracket 2. The mounting mechanism 12 is operative coupled to the resting bracket 2 so that the removable propane tanks can be tethered, strapped, or mechanical locked to prevent tip overing of the removable propane tanks. The vehicular propane inlet regulator 13 is operative coupled to the resting bracket 2 so that the removable propane tanks are in fluid communication with the recreational vehicle. In other words, once the inlet regulator 13 is hermetically coupled with the removable propane tanks, a continuous flow of propane gas can be supplied to accessories of the recreational vehicle.

The hard-wired vehicular power connector 15 is electrically connected to the vehicular battery so that the tank measuring sensor 14 can be directly powered. More specifically, the hard-wired vehicular power connector 15 pulls electrical current directly from the vehicular battery so that a steady stream of electrical current can be supplied to the tank measuring sensor 14. Preferably, the hard-wired vehicular power connector 15 is routed through the vehicular electrical fuse box to prevent continuous battery drainage. In other words, the hard-wired vehicular power connector 15 only pulls electrical power from the vehicular battery when the ignition switch is at the on-position. If necessary, the hard-wired vehicular power connector 15 can also be configured into a direct-electrical connection wherein the tank measuring sensor 14 continuously powers regardless of the status of the ignition switch.

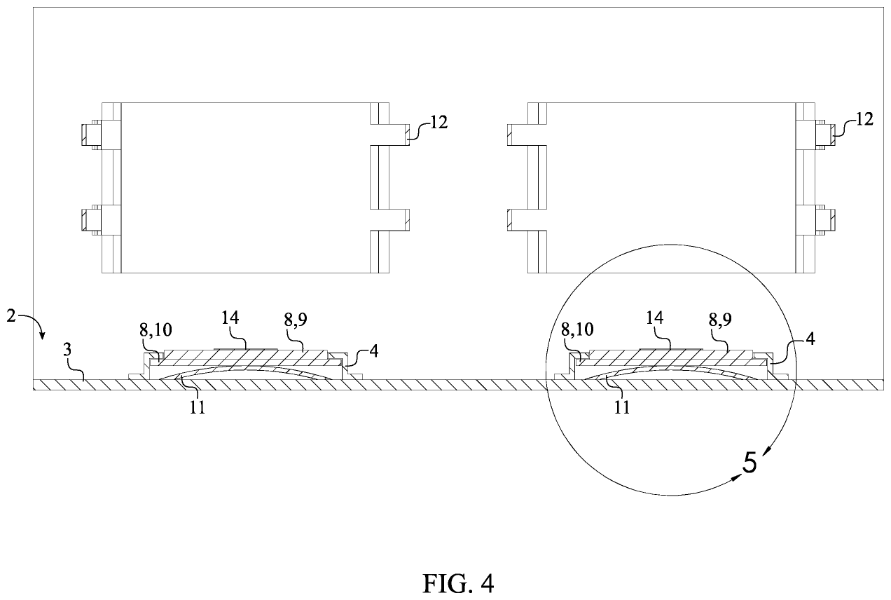

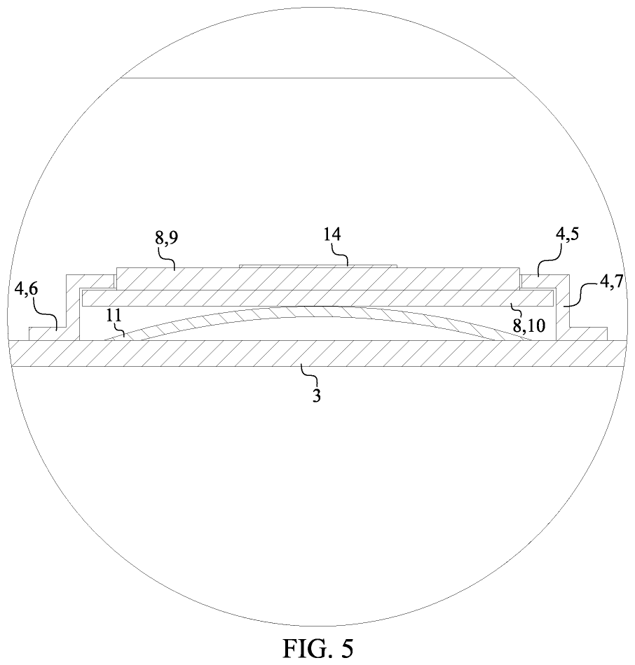

In reference to FIGS. 4-5, the resting bracket 2 that engages with the removable propane tank from the bottom end comprises a platform 3, at least one annular housing 4, at least one contact plate 8, and at least one spring support 11. More specifically, a bottom edge 6 of the annular housing 4 is perimetrically connected to the platform 3 so that the annular housing 4 can be extended above the platform 3. The spring support 11 is concentrically positioned within the annular housing 4 and terminally connected onto the platform 3. The spring support 11 can be a spring body, a leaf-spring body, or any other elastic device. The contact plate 8 is positioned within the annular housing 4 and compressionally engaged between a top edge 5 of the annular housing 4 and the spring support 11. As a result, the spring support 11 pushes the contact plate 8 up against the top edge 5.

In reference to FIG. 5, the annular housing 4 further comprises a cylinder foot ring receiving body 7 so that the bottom end of the removable propane tank can be aligned with the resting bracket 2. The cylinder foot ring receiving body 7 is position in between the top edge 5 and the bottom edge 6 and provides the height of the annular housing 4. More specifically, the top edge 5 is perpendicularly connected to the cylinder foot ring receiving body 7. the bottom edge 6 is perpendicularly connected to the cylinder foot ring receiving body 7. The top edge 5 and the bottom edge 6 are positioned parallel to each other and oriented in the opposite direction. In other words, the bottom edge 6 is outwardly extended from the cylinder foot ring receiving body 7 while the top edge 5 is inwardly extended towards the cylinder foot ring receiving body 7. When the removable propane tank is aligned and positioned around the annular housing 4, the bottom edge 6 of the removable propane tank, preferably the foot ring section of the propane tank, is concentrically positioned around the cylinder foot ring receiving body 7 thus preventing lateral movement.

In reference to FIGS. 4-5, the contact plate 8 comprises a cylinder bottom receiving plate 9 and a retainer plate 10 as the contact plate 8 pressed up against a cylinder bottom of the removable propane tank. More specifically, the cylinder bottom receiving plate 9 and the retainer plate 10 are concentrically positioned of each other and adjacently connected to each other. The cylinder bottom receiving plate 9 is concentrically positioned within the top edge 5, wherein the cylinder bottom receiving plate 9 is positioned offset from the top edge 5 and oriented outward. The retainer plate 10 is concentrically positioned within the cylinder foot ring receiving body 7 and positioned in between the cylinder bottom receiving plate 9 and the spring support 11. As a result, the contact plate 8 is contained within the cylinder foot ring receiving body 7 by the retainer plate 10 while the contact plate 8 is freely engaged above the cylinder foot ring receiving body 7.

In reference to FIGS. 4-5, the tank measuring sensor 14 is operatively integrated into the cylinder bottom receiving plate 9 of the contact plate 8 so that the remaining amount of liquid in the removable propane tanks can be measured. Since the cylinder bottom receiving plate 9 is ushed up against the cylinder bottom of the removable propane tank, the resting bracket 2 is able to eliminate any dead space between the tank measuring sensor 14 and the cylinder bottom of the removable propane tank. The tank measuring sensor 14 preferably utilizes a transducer to measure the remaining amount of liquid in the removable propane tanks. However, the tank measuring sensor 14 can utilize any other types of liquid measuring devices or technology within the corresponding field to measure the remaining amount of liquid in the removable propane tanks.

The main control module 16 process the data upload by the tank measuring sensor 14 so that the uploaded data can be presented to the user. Furthermore, the main control module 16 can be a stand along device or can be intergrade into the electronic control unit (ECU) of the recreational vehicle.

The vehicular display module 17 displays and informs the user about the measurements of the tank measuring sensor 14. In the preferred embodiment, the display device is, but not limited to, an internal panel, a digital screen, or integrated into the main vehicular display panel.

Although the invention has been explained in relation to its preferred embodiment, it is to be understood that many other possible modifications and variations can be made without departing from the spirit and scope of the invention as hereinafter claimed.

What is claimed is:

1. A vehicle mounted monitoring system for removable propane tanks comprising:
a propane tank holding system;
at least one tank measuring sensor;
a hard-wired vehicular power connector;
a main control module;
a vehicular display module;
the propane tank holding system comprising at least one resting bracket;
the tank measuring sensor being operatively coupled to the resting bracket;
the hard-wired vehicular power connector being electrically connected to the tank measuring sensor; and
the tank measuring sensor being electronically connected to the vehicular display module through the main control module.

2. The vehicle mounted monitoring system for removable propane tanks as claimed in claim 1 comprising:
the resting bracket comprising a platform, at least one annular housing, at least one contact plate, and at least one spring support;
a bottom edge of the annular housing being perimetrically connected to the platform;
the spring support being concentrically positioned within the annular housing;
the spring support being terminally connected onto the platform;
the contact plate being positioned within the annular housing; and
the contact plate being compressionally engaged between a top edge of the annular housing and the spring support.

3. The vehicle mounted monitoring system for removable propane tanks as claimed in claim 2 comprising:
the annular housing further comprising a cylinder foot ring receiving-body;
the cylinder foot ring receiving-body being position in between the top edge and the bottom edge;
the top edge being perpendicularly connected to the cylinder foot ring receiving-body;
the bottom edge being perpendicularly connected to the cylinder foot ring receiving-body; and
the top edge and the bottom edge being positioned parallel to each other.

4. The vehicle mounted monitoring system for removable propane tanks as claimed in claim 2 comprising:
the contact plate comprising a cylinder bottom receiving plate and a retainer plate;
the cylinder bottom receiving plate and the retainer plate being concentrically positioned of each other;
the cylinder bottom receiving plate and the retainer plate being adjacently connected to each other;
the cylinder bottom receiving plate being concentrically positioned within the top edge;
the retainer plate being concentrically positioned within a cylinder foot ring receiving-body of the annular housing;
the cylinder bottom receiving plate being positioned offset from the top edge; and
the retainer plate positioned in between the cylinder bottom receiving plate and the spring support.

5. The vehicle mounted monitoring system for removable propane tanks as claimed in claim 1 comprising:
the resting bracket comprising a contact plate; and
the tank measuring sensor being operatively integrated into a cylinder bottom receiving plate of the contact plate.

6. The vehicle mounted monitoring system for removable propane tanks as claimed in claim 1 comprising:
the propane tank holding system further comprising at least one mounting mechanism; and
the mounting mechanism being operative coupled to the resting bracket.

7. The vehicle mounted monitoring system for removable propane tanks as claimed in claim 1 comprising:
the propane tank holding system further comprising a vehicular propane inlet regulator; and
the vehicular propane inlet regulator being operative coupled to the resting bracket.
